(19) United States
(12) Patent Application Publication
(10) Pub. No.: US 2022/0309596 A1
(43) Pub. Date: Sep. 29, 2022

(54) RECIPE PROVIDING SYSTEM, RECIPE PROVIDING METHOD, MANAGEMENT SERVER, AND MANAGEMENT METHOD

(71) Applicant: Toshiba Tec Kabushiki Kaisha, Tokyo (JP)

(72) Inventor: Yumiko OKUMA, Tokyo (JP)

(73) Assignee: Toshiba Tec Kabushiki Kaisha, Tokyo (JP)

(21) Appl. No.: 17/552,795

(22) Filed: Dec. 16, 2021

(30) Foreign Application Priority Data
Mar. 26, 2021 (JP) 2021-053557

(51) Int. Cl. G06Q 50/12; G06F 16/93

(52) U.S. Cl. CPC G06Q 50/12; G06F 16/93

(57) ABSTRACT

A recipe providing system includes a recipe server, a net supermarket server that sells a commodity using a network, and a management server. The recipe server includes a recipe storing means for storing recipes related to cooking of a dish provided by a restaurant for each restaurant so that the recipes are browsed from a user terminal owned by a user of the recipe, the net supermarket server includes a settlement means for performing a settlement process related to a commodity based on commodity information of the commodity corresponding to ingredients of the dish included in a recipe to be used among the recipes browsed by the user on the recipe server, and the management server includes a usage fee notifier for notifying the restaurant of a recipe usage fee calculated based on a settlement amount obtained by being subjected to the settlement process.

### CROSS-REFERENCE TO RELATED APPLICATION

This application is based upon and claims the benefit of priority from Japanese Patent Application No. 2021-053557, filed on Mar. 26, 2021, the entire contents of which are incorporated herein by reference.

### FIELD

Embodiments described herein relate generally to a recipe providing system, a recipe providing method, a management server, and a management method.

### BACKGROUND

Conventionally, a person who consumed food or beverages at a restaurant may not be able to reproduce a taste of the dish or drink at the restaurant even if he or she tried to reproduce the taste of the dish at home. This may be because know-how, such as timing and hidden taste factors, is not disclosed even if a food ingredient, quantity, and method of cooking the dish are known.

### DESCRIPTION OF THE DRAWINGS

FIG. 1 is a diagram including a recipe providing system according to at least one embodiment;

FIG. 2 is an explanatory diagram illustrating the recipe providing system;

FIG. 3 is a block diagram illustrating a hardware configuration of a recipe server;

FIG. 4 is a memory map illustrating a configuration of a recipe storage portion;

FIG. 5 is a block diagram illustrating a hardware configuration of a net supermarket server;

FIG. 6 is a memory map illustrating a configuration of a recipe information portion;

FIG. 7 is a block diagram illustrating a hardware configuration of an electronic receipt server;

FIG. 8 is a memory map illustrating a configuration of a user information portion;

FIG. 9 is a block diagram illustrating a hardware configuration of a management server;

FIG. 10 is a memory map illustrating the configuration of the user information portion;

FIG. 11 is a memory map illustrating a configuration of a restaurant information portion;

FIG. 12 is a functional block diagram illustrating a functional configuration of the recipe server;

FIG. 13 is a flowchart illustrating a flow of a control process of the recipe server;

FIG. 14 is a functional block diagram illustrating a functional configuration of the net supermarket server;

FIG. 15 is a flowchart illustrating a flow of a control process of the net supermarket server;

FIG. 16 is a functional block diagram illustrating a functional configuration of the electronic receipt server;

FIG. 17 is a flowchart illustrating a flow of a control process of the electronic receipt server;

FIG. 18 is a functional block diagram illustrating a functional configuration of the management server; and

FIG. 19 is a flowchart illustrating a flow of a control process of the management server.

### DETAILED DESCRIPTION

As noted, it may be desirable to reproduce a particular dish or drink experienced at a restaurant, for example. On the other hand, even in restaurants, although there is a desire to receive compensation by disclosing recipes related to the dish or dish, the desire to get compensation may not be realized due to the lack of a suitable mechanism.

An object of at least one embodiment is to provide a recipe providing system, a recipe providing method, a management server, and a management method with which it is possible to reproduce a taste of a dish at a restaurant with a disclosed recipe and to notify the restaurant of a compensation for disclosure of the recipe. References herein to a “meal,” a “meal item” or a “dish” are understood to encompass meal components such as food and/or beverages.

In general, according to at least one embodiment, a recipe providing system includes a recipe server, a net supermarket server that sells a commodity using a network, and a management server. The recipe server includes a recipe storing means (storage) for storing recipes related to preparing (cooking) of a dish provided by a restaurant for each restaurant so that the recipes are browsed from a user terminal owned by a user of the recipe, the net supermarket server includes a settlement means (settlement processor or register) for performing a settlement process related to a commodity based on commodity information of the commodity corresponding to ingredients of the dish included in a recipe to be used among the recipes browsed by the user on the recipe server, and the management server includes a usage fee notification means (notifier) such as a communication interface for notifying the restaurant of a recipe usage fee calculated based on a settlement amount obtained by being subjected to the settlement process.

Hereinafter, embodiments will be described with reference to the drawings. The at least one embodiment is a mechanism in which a restaurant discloses a recipe of a dish provided to a customer (user) at the restaurant, and the user using the recipe can purchase a commodity corresponding to ingredients included in the recipe, and a recipe usage fee is paid to a store that discloses the recipe.

This mechanism is configured with a restaurant terminal provided in the restaurant, a recipe server for storing the recipes, a net supermarket server, an electronic receipt server, a management server, and a user terminal owned by the user.

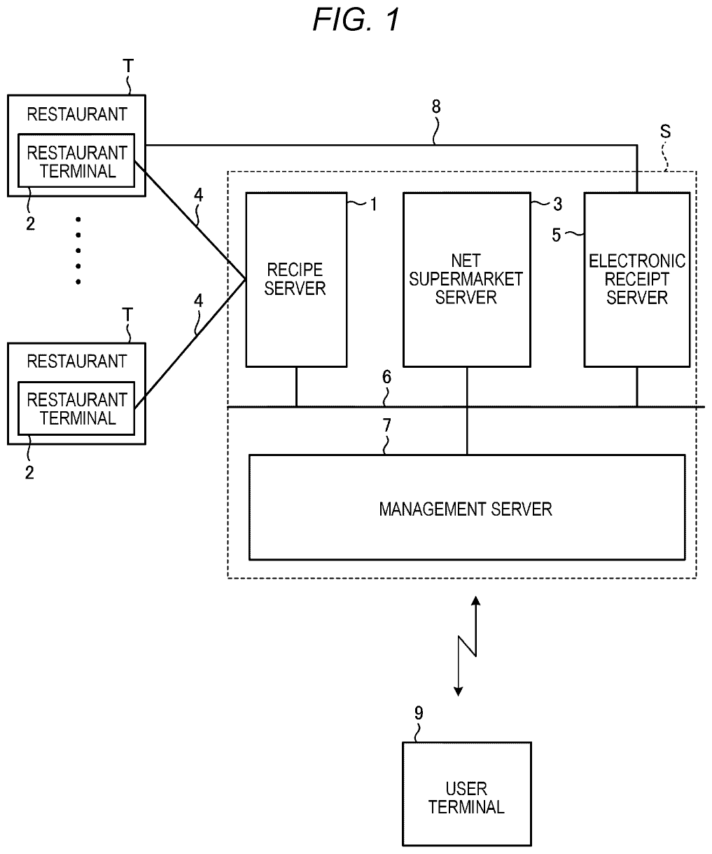

FIG. 1 is a diagram including a recipe providing system S according to at least one embodiment. In the embodiment, the recipe providing system S includes a recipe server 1, a net supermarket server 3, an electronic receipt server 5, and a management server 7. The recipe server 1, the net supermarket server 3, the electronic receipt server 5, and the management server 7 are electrically connected by, for example, a communication line 6 such as a dedicated line, and can transmit and receive information and signals to and from each other. The supermarket server 3 and the management server 7 each are provided with processing circuitry in the form one or more processors configured to carry out various operations as described below.

A restaurant T is provided with a restaurant terminal 2. The restaurant terminal 2 is a personal computer (PC), a smartphone, a tablet terminal, a personal digital assistant (PDA), or the like. The restaurant terminal 2 stores information on a recipe (hereinafter referred to as “recipe”) that may be disclosed to the outside among recipes related to a dish provided to the user who is a customer at the restaurant T. The recipe includes, in addition to a name of a dish, ingredient information indicating a type and amount of ingredients (food materials), information such as seasonings, cooking methods (including photos), photos of presentation, and the like, information on know-how (cooking order, timing of adding ingredients and seasonings, adjustment of heating, hidden taste, secret seasonings, and the like) that the restaurant T does not normally disclose. A specific ingredient may be used as the ingredient, and the ingredient information includes such information. For example, if a specific type of ingredient is used, if an ingredient of a specific production area is used, if an ingredient of a specific manufacturer is used, or the like, the ingredient information is also stored together with such information. The recipe also includes a restaurant code that specifies the restaurant that disclosed the recipe.

The recipe server 1 is communicably connected to the restaurant terminal 2 installed in each of the plurality of restaurants T (a case where the restaurant terminal is carried by a restaurant salesclerk, and the like is also included in the cases of the installation) by a communication line 4. The recipe server 1 receives and stores the recipe from the restaurant terminal 2. The recipe server 1 stores the recipe for each restaurant terminal 2 (that is, for each restaurant T).

The net supermarket server 3 is a server for shopping on a network using a user terminal 9 owned by the user via the communication line 6. The net supermarket server 3 stores information on the commodity sold at a store (real store or virtual store) and performs a settlement process for the commodity purchased by the user. The net supermarket server 3 receives information of the ingredient included in the recipe that the user decides to use among the recipes that the user browsed on the recipe server 1, provides commodity information of a commodity (e.g. an edible item) corresponding to the ingredient to the user, and sells the commodity to the user.

The electronic receipt server 5 stores electronic receipt information, which is obtained by digitizing commodity information (commodity code that specifies the commodity, commodity name, price, and the like), settlement information (total amount, settlement amount, and the like), and the like related to the commodity subjected to the settlement process by the net supermarket server 3, for each user. The electronic receipt server 5 is connected to the restaurant terminal 2 of each restaurant T (to be exact, restaurant T, which is a member that uses an electronic receipt mechanism) by a communication line 8, and receives the commodity information and the settlement information of the dish that the user ate and drank and is subjected to settlement by the restaurant T and stores the electronic receipt information related to the information for each user. The electronic receipt server 5 transmits the stored electronic receipt information to the user terminal 9 in a displayable manner in response to a browsing request from the user terminal 9 (that is, a user).

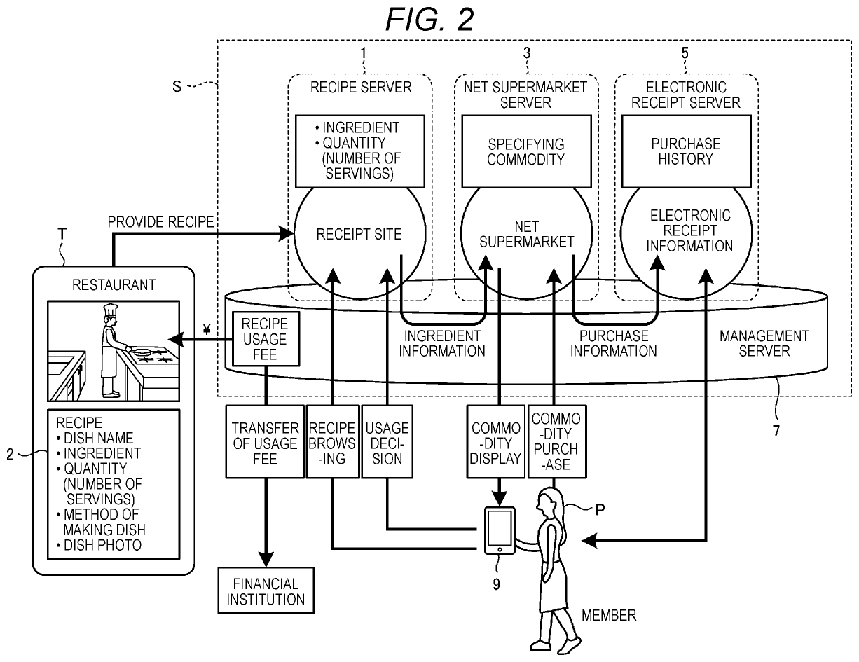

From here, the recipe providing system S will be described. FIG. 2 is an explanatory diagram illustrating the recipe providing system S. As illustrated in FIG. 2, salesclerk or the like of the restaurant T causes the restaurant terminal 2 to store the recipe for each dish. The restaurant terminal 2 stores the recipe for each dish. If the restaurant T is a member of the electronic receipt mechanism, among the recipes stored in the restaurant terminal 2, a recipe to be disclosed to the user is transmitted to the recipe server 1 at a desired timing together with a restaurant code that specifies the restaurant terminal 2 (that is, the restaurant). The recipe server 1 stores the recipe and the restaurant code received from the restaurant terminal 2 for each restaurant T.

A user P who uses the recipe holds the user terminal 9. The user terminal 9 is a PC, a smartphone, a tablet terminal, a PDA, or the like. The user terminal 9 stores a user code that specifies the user terminal 9.

The user P can access the recipe server 1 (that is, a recipe site) using the user terminal 9 and browse the recipe stored in the recipe server 1. If the recipe that the user P wants to use from the browsed recipes is present, the user P performs a usage decision operation of the recipe from the user terminal 9. Usage decision information is transmitted to the recipe server 1 together with the user code of the user terminal 9.

If the recipe server 1 receives the usage decision information from the user terminal 9, the recipe server 1 transmits ingredient information (food material information) included in the decided recipe to the management server 7 together with the restaurant code and the user code. The management server 7 transfers the ingredient information, the restaurant code, and the user code received from the recipe server 1 to the net supermarket server 3.

If the net supermarket server 3 receives the ingredient information, the restaurant code, and the user code from the management server 7, the net supermarket server 3 specifies a commodity corresponding to the ingredient information. Then, the net supermarket server 3 transmits commodity information of the decided commodity to the management server 7 together with the user code. The management server 7 transmits the received commodity information to the user terminal 9 specified by the user code in a displayable manner.

The user terminal 9 displays the received commodity information. The user P browses the displayed commodity information and determines whether to purchase the commodity. If purchasing the commodity, the user P operates a purchase button. If the purchase button is operated, the user terminal 9 transmits a signal indicating commodity purchase to the management server 7. The management server 7 transfers the received signal indicating the commodity purchase to the net supermarket server 3.

If the net supermarket server 3 receives the signal indicating the commodity purchase from the management server 7, the net supermarket server 3 executes a settlement process related to the commodity. The settlement process is performed using, for example, credit card information of the user P registered in advance. Alternatively, a process of withdrawing a settlement amount from a user's account registered in advance is performed. The net supermarket server 3 transmits the commodity information and the settlement information of the commodity subjected to the settlement process (commodity information and settlement information are collectively called “purchase information”) to the management server 7. The management server 7 transmits the received purchase information together with the user code to the electronic receipt server 5.

The electronic receipt server 5 generates electronic receipt information related to the transaction based on the received purchase information, and stores the electronic receipt information for each user P. The electronic receipt server 5 generates electronic receipt information related to foods of the user P at the restaurant T based on food information received from the communication line 8, and stores the electronic receipt information for each user P. If a browsing request is issued from the user terminal 9, the electronic receipt server 5 transmits the electronic receipt information to the user terminal 9 in a displayable manner.

If the management server 7 receives the purchase information and the restaurant code from the net supermarket server 3, the management server 7 calculates a recipe usage fee based on the settlement amount included in the purchase information. Since the recipe usage fee is determined in advance as a percentage of the settlement amount, the management server 7 calculates the recipe usage fee based on the settlement amount if the purchase amount is received. The management server 7 transmits information of the calculated recipe usage fee to the restaurant terminal 2. The restaurant terminal 2 stores the received information of the recipe usage fee. The management server 7 performs a transfer process of transferring the calculated recipe usage fee to, for example, an account of the restaurant T of a financial institution registered in advance.

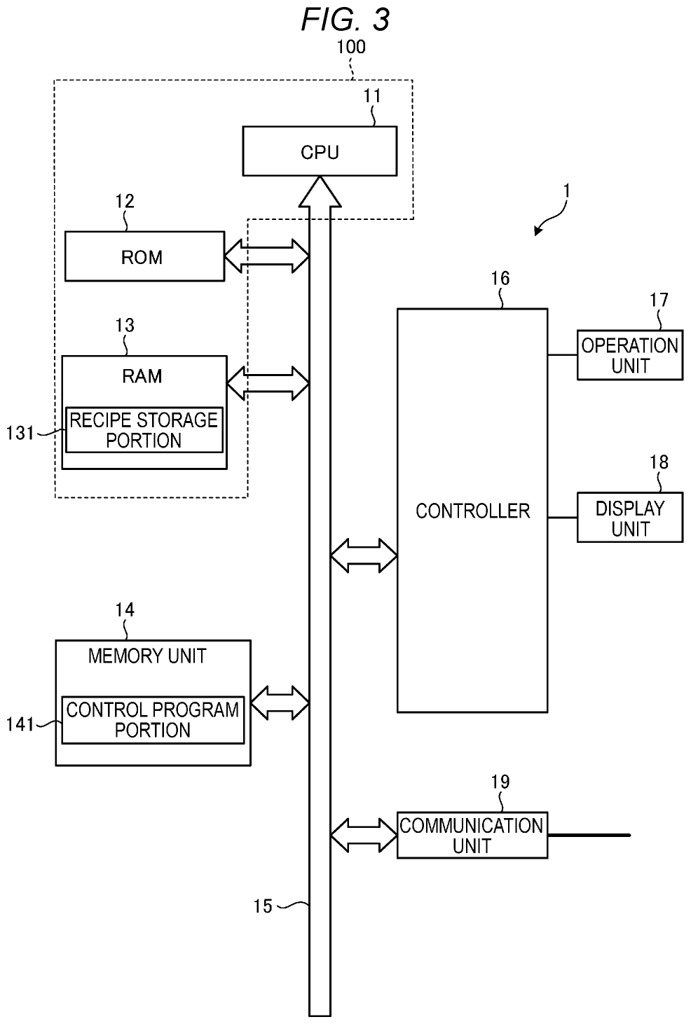

Hardware of the recipe server 1 will now be described. FIG. 3 is a block diagram illustrating a hardware configuration of the recipe server 1. As illustrated in FIG. 3, the recipe server 1 includes a central processing unit (CPU) 11, a read only memory (ROM) 12, a random access memory (RAM) 13, a memory unit 14, and the like. The CPU 11 is a control main body. The ROM 12 stores various programs. The RAM 13 loads programs and various data. The memory unit 14 stores various programs. The CPU 11, the ROM 12, the RAM 13, and the memory unit 14 are connected to each other via a bus 15. The CPU 11, ROM 12, and RAM 13 configure a control unit 100. That is, the control unit 100 executes a control process of the recipe server 1, which will be described later, by operating the CPU 11 according to a control program stored in the ROM 12 or the memory unit 14 and loaded in the RAM 13.

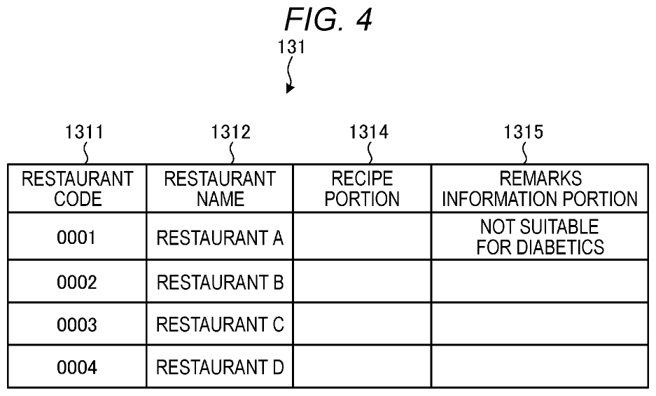

The RAM 13 includes a recipe storage portion 131. The recipe storage portion 131 stores the recipes disclosed by the restaurant T and required for the user P to cook the dish for each restaurant T. The recipe storage portion 131 will be described later with reference to FIG. 4.

The memory unit 14 is configured with a non-volatile memory such as a hard disk drive (HDD) or a flash memory that latches stored information even if a power is cut off, and includes a control program portion 141 that stores a control program that controls the recipe server 1.

The control unit 100 is connected to an operation unit 17 and a display unit 18 via the bus 15 and a controller 16. The controller 16 receives an instruction from the control unit 100 to control the operation unit 17 and the display unit 18. However, for convenience of explanation, description will be made in such away that the control unit 100 performs the control performed by the controller 16. The operation unit 17 is, for example, a keyboard or a touch panel, and is operated by an operator of the recipe server 1. The display unit 18 is, for example, a liquid crystal display, and displays information to the operator of the recipe server 1.

The control unit 100 is connected to a communication unit 19 via the bus 15. The communication unit 19 is connected to the restaurant terminal 2 of the store that is a member that uses an electronic receipt mechanism via the communication line 4. The communication unit 19 is connected to the net supermarket server 3, the electronic receipt server 5, and the management server 7 via the communication line 6.

The recipe storage portion 131 will now be described. FIG. 4 is a memory map illustrating a configuration of the recipe storage portion 131. As illustrated in FIG. 4, the recipe storage portion 131 includes a restaurant code portion 1311, a restaurant name portion 1312, a recipe portion 1314, and a remarks information portion 1315. The restaurant code portion 1311 stores the restaurant code that specifies the restaurant terminal 2 (that is, the restaurant T) that disclosed the recipe. The restaurant name portion 1312 stores a store name of the restaurant T specified by the restaurant code stored in the restaurant code portion 1311. The recipe portion 1314 stores the recipe corresponding to a recipe code stored in a recipe code portion 1313. The recipe portion 1314 stores the recipe code for specifying the recipe. The remarks information portion 1315 stores information related to the recipe stored in the recipe portion 1314. For example, if the ingredients included in the recipe stored in the recipe portion 1314 include an ingredient that cannot be ingested due to a specific illness, the information is stored. For example, if the recipe includes the ingredient that cannot be ingested by a person with specific chronic illnesses, the remarks information portion 1315 stores information indicating that the recipe is not suitable for a person with the illness. For example, if the recipe includes an ingredient that cannot be ingested by a person with an allergic constitution, information indicating that the recipe is not suitable for a person with a specific allergic constitution is stored.

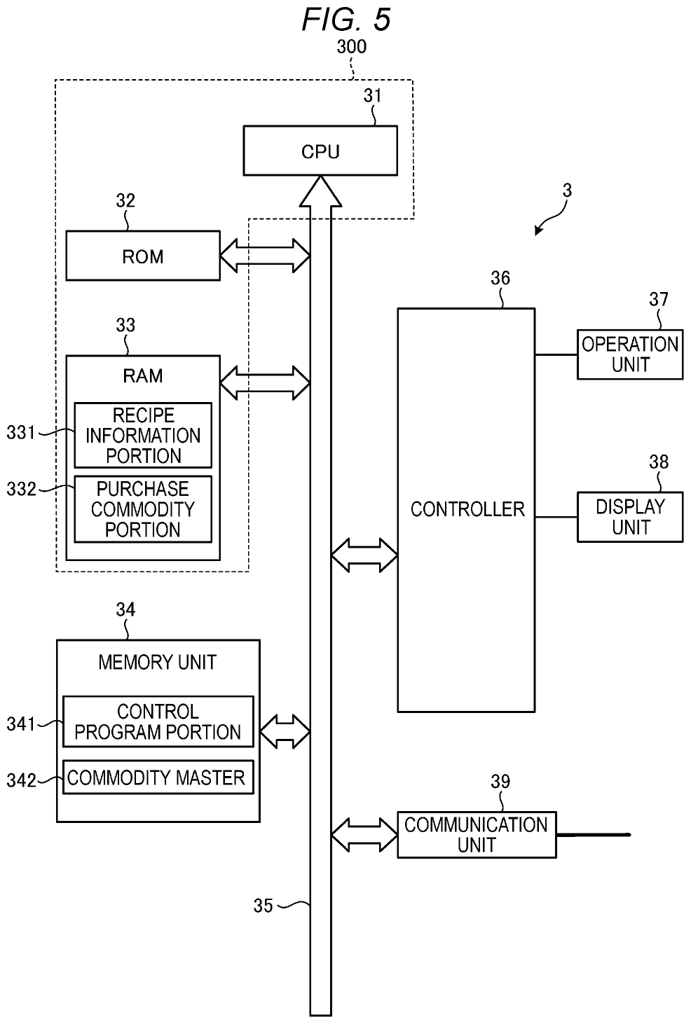

Hardware of the net supermarket server 3 will now be described. FIG. 5 is a block diagram illustrating a hardware configuration of the net supermarket server 3. As illustrated in FIG. 5, the net supermarket server 3 includes a CPU 31, a ROM 32, a RAM 33, a memory unit 34, and the like. The CPU 31 is a control main body. The ROM 32 stores various programs. The RAM 33 loads programs and various data. The memory unit 34 stores various programs. The CPU 31, the ROM 32, the RAM 33, and the memory unit 34 are connected to each other via a bus 35. The CPU 31, ROM 32, and RAM 33 configure a control unit 300. That is, the control unit 300 executes a control process of the net supermarket server 3, which will be described later, by operating the CPU 31 according to a control program stored in the ROM 32 or the memory unit 34 and loaded in the RAM 33.

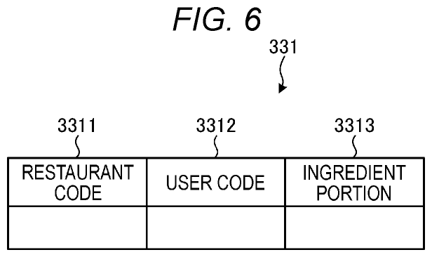

The RAM 33 includes a recipe information portion 331 and a purchase commodity portion 332. The recipe information portion 331 stores information of the recipe that the user P decided to use among the recipes browsed on the recipe server 1. The purchase commodity portion 332 stores commodity information (including a commodity code that specifies the commodity, a commodity name, a price, and the like) of the commodity corresponding to the ingredient included in the recipe decided to be used. The recipe information portion 331 will be described later with reference to FIG. 6. The purchase commodity portion 332 stores the commodity information of the commodity that the user decided to purchase.

The memory unit 34 is configured with a non-volatile memory such as the HDD or the flash memory that latches stored information even if a power is cut off, and includes a control program portion 341 that stores a control program for controlling the net supermarket server 3 and a commodity master 342. The commodity master 342 stores commodity information such as the commodity name and price of the commodity in correlation with the commodity code that specifies the commodity.

The control unit 300 is connected to an operation unit 37 and a display unit 38 via the bus 35 and a controller 36. The controller 36 receives an instruction from the control unit 300 to control the operation unit 37 and the display unit 38. However, for convenience of explanation, description will be made in such away that the control unit 300 performs the control performed by the controller 36. The operation unit 37 is, for example, a keyboard or a touch panel, and is operated by an operator of the net supermarket server 3. The display unit 38 is, for example, a liquid crystal display, and displays information to the operator of the net supermarket server 3.

The control unit 300 is connected to a communication unit 39 via the bus 35. The communication unit 39 is connected to the recipe server 1, the electronic receipt server 5, and the management server 7 via the communication line 6.

From here, the recipe information portion 331 will be described. FIG. 6 is a memory map illustrating a configuration of the recipe information portion 331. As illustrated in FIG. 6, the recipe information portion 331 includes a restaurant code portion 3311, a user code portion 3312, and an ingredient portion 3313. The restaurant code portion 3311 stores the restaurant code that specifies the restaurant T that disclosed the recipe that the user P decided to use. The user code portion 3312 stores a user code that specifies the user terminal 9 (that is, specifies user P) owned by the user P who uses the recipe. The ingredient portion 3313 stores the ingredient information included in the recipe stored in the restaurant code portion 3311. If a commodity corresponding to the ingredient, which is the ingredient stored in the ingredient portion 3313 required when the user P cooks a dish using the recipe, is purchased by the user P, the commodity information of the commodity is stored in the purchase commodity portion 332.

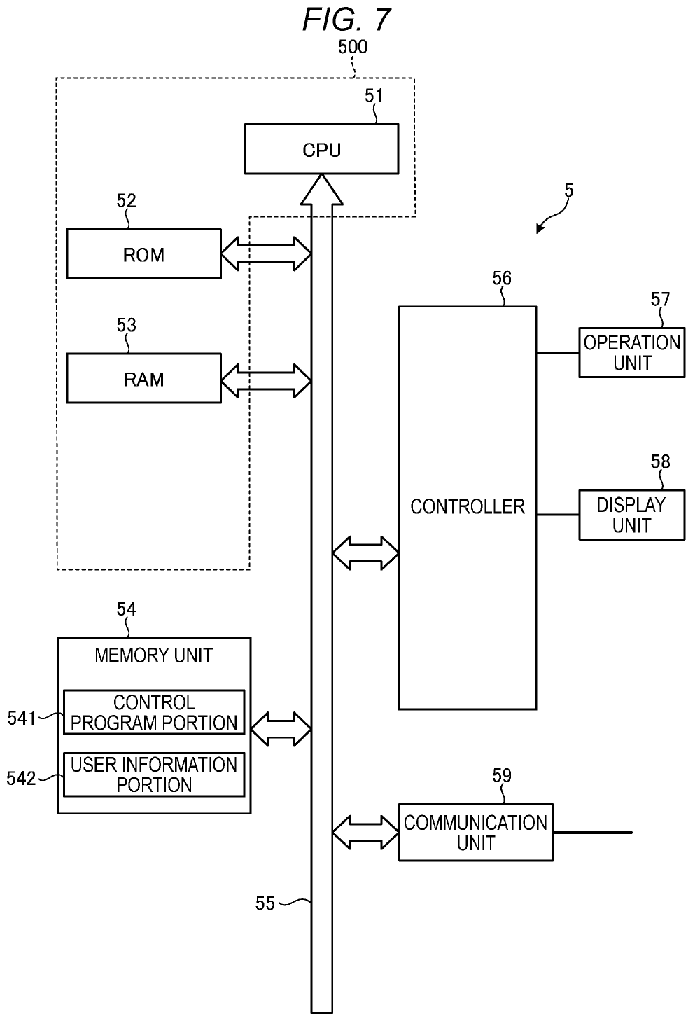

Hardware of the electronic receipt server 5 will now be described. FIG. 7 is a block diagram illustrating a hardware configuration of the electronic receipt server 5. As illustrated in FIG. 7, the electronic receipt server 5 includes a CPU 51, a ROM 52, a RAM 53, a memory unit 54, and the like. The CPU 51 is a control main body. The ROM 52 stores various programs. The RAM 53 loads programs and various data. The memory unit 54 stores various programs. The CPU 51, the ROM 52, the RAM 53, and the memory unit 54 are connected to each other via a bus 55. The CPU 51, ROM 52, and RAM 53 configure a control unit 500. That is, the control unit 500 executes a control process of the electronic receipt server 5, which will be described later, by operating the CPU 51 according to a control program stored in the ROM 52 or the memory unit 54 and loaded in the RAM 53.

The memory unit 54 is configured with a non-volatile memory such as the HDD or the flash memory that latches stored information even if a power is cut off, and includes a control program portion 541 that stores a control program that controls the electronic receipt server 5 and a user information portion 542. The user information portion 542 accumulates and stores electronic receipt information for each user code that specifies the user P.

The control unit 500 is connected to an operation unit 57 and a display unit 58 via the bus 55 and a controller 56. The controller 56 receives an instruction from the control unit 500 to control the operation unit 57 and the display unit 58. However, for convenience of explanation, description will be made in such away that the control unit 500 performs the control performed by the controller 56. The operation unit 57 is, for example, a keyboard or a touch panel, and is operated by an operator of the electronic receipt server 5. The display unit 58 is, for example, a liquid crystal display, and displays information to the operator of the electronic receipt server 5.

The control unit 500 is connected to a communication unit 59 via the bus 55. The communication unit 59 is connected to the recipe server 1, the net supermarket server 3, and the management server 7 via the communication line 6.

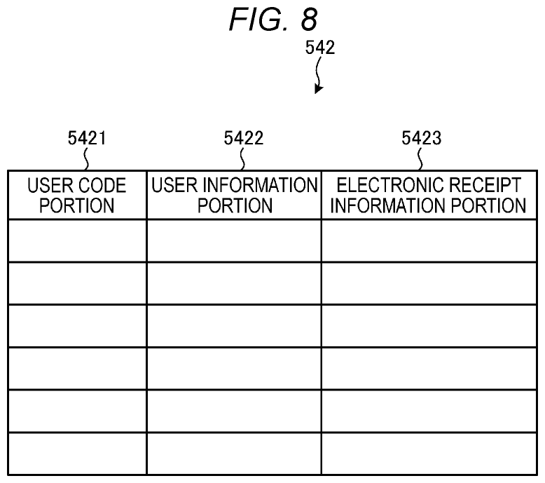

The user information portion 542 will now be described. FIG. 8 is a memory map illustrating a configuration of the user information portion 542. As illustrated in FIG. 8, the user information portion 542 includes a user code portion 5421, a user information portion 5422, and an electronic receipt information portion 5423. The user code portion 5421 stores a user code that specifies a customer (user). The user information portion 5422 stores user information (name, address, phone number, email address, and the like) of the user P that is stored in correlation with the user code stored in the user code portion 5421 and specified by the user code stored in the user code portion 5421. The electronic receipt information portion 5423 accumulates and stores electronic receipt information of the user P specified by the user code stored in the user code portion 5421. The electronic receipt information portion 5423 stores the electronic receipt information related to the commodity purchased by the user P from the store that operates the net supermarket server 3 and the electronic receipt information related to the dish that the user P ate and drank at the restaurant T together with the restaurant code. For that reason, by searching the electronic receipt information portion 5423, it is possible to analyze which user P is using which recipe and how much.

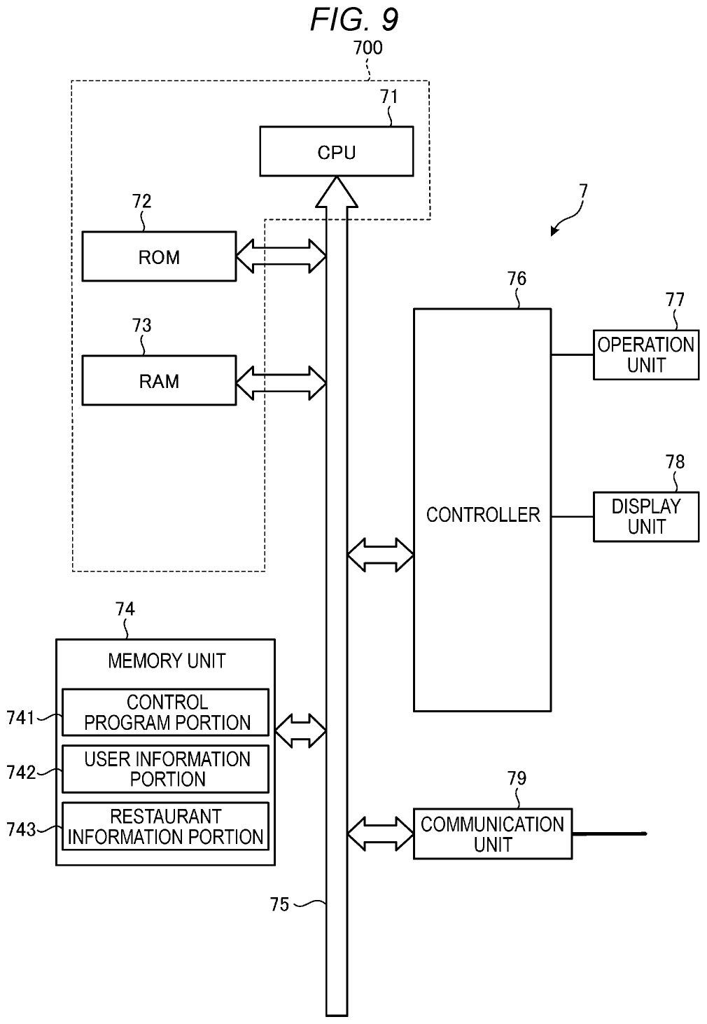

Hardware of the management server 7 will now be described. FIG. 9 is a block diagram illustrating a hardware configuration of the management server 7. As illustrated in FIG. 9, the management server 7 includes a CPU 71, a ROM 72, a RAM 73, a memory unit 74, and the like. The CPU 71 is a control main body. The ROM 72 stores various programs. The RAM 73 loads programs and various data. The memory unit 74 stores various programs. The CPU 71, the ROM 72, the RAM 73, and the memory unit 74 are connected to each other via a bus 75. The CPU 71, ROM 72, and RAM 73 configure a control unit 700. That is, the control unit 700 executes a control process of the management server 7, which will be described later, by operating the CPU 71 according to a control program stored in the ROM 72 or the memory unit 74 and loaded in the RAM 73.

The memory unit 74 is configured with a non-volatile memory such as the HDD or the flash memory that latches stored information even if a power is cut off, and includes a control program portion 741 that stores a control program for controlling the management server 7, a user information portion 742, and a restaurant information portion 743. The user information portion 742 stores an address of the user terminal 9 owned by the user P for each user code that specifies the user P. The user information portion 742 will be described later with reference to FIG. 11. The restaurant information portion 743 stores an address of the restaurant terminal 2 of the restaurant T for each restaurant code that specifies the restaurant T.

The control unit 700 is connected to an operation unit 77 and a display unit 78 via the bus 75 and a controller 76. The controller 76 receives an instruction from the control unit 700 to control the operation unit 77 and the display unit 78. However, for convenience of explanation, description will be made in such away that the control unit 700 performs the control performed by the controller 76. The operation unit 77 is, for example, a keyboard or a touch panel, and is operated by an operator of the management server 7. The display unit 78 is, for example, a liquid crystal display, and displays information to the operator of the management server 7.

The control unit 700 is connected to a communication unit 79 via the bus 75. The communication unit 79 is connected to the recipe server 1, the net supermarket server 3, and the electronic receipt server 5 via the communication line 6.

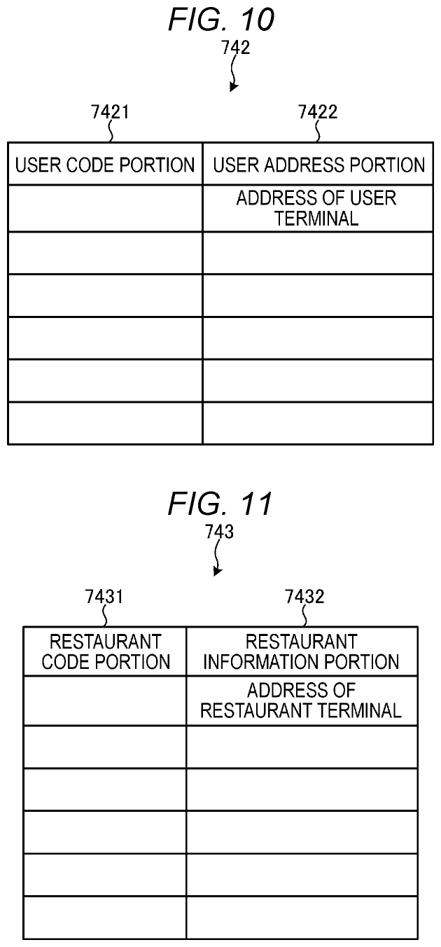

From here, the user information portion 742 will be described. FIG. 10 is a memory map illustrating a configuration of the user information portion 742. As illustrated in FIG. 10, the user information portion 742 includes a user code portion 7421 and a user address portion 7422. The user code portion 7421 stores a user code that specifies the user terminal 9 owned by the user P. The user address portion 7422 stores user information (name, address, phone number, email address, and the like) of the user P that is stored in correlation with the user code stored in the user code portion 7421 and specified by the user code stored in the user code portion 7421.

The restaurant information portion 743 will now be described. FIG. 11 is a memory map illustrating a configuration of the restaurant information portion 743. The restaurant information portion 743 includes a restaurant code portion 7431 and a restaurant information portion 7432. The restaurant code portion 7431 stores the restaurant code that specifies the restaurant terminal 2 provided in the restaurant T. The restaurant information portion 7432 stores an address of the restaurant terminal 2 stored in correlation with the restaurant code stored in the restaurant code portion 7431 and specified by the restaurant code stored in the restaurant code portion 7431.

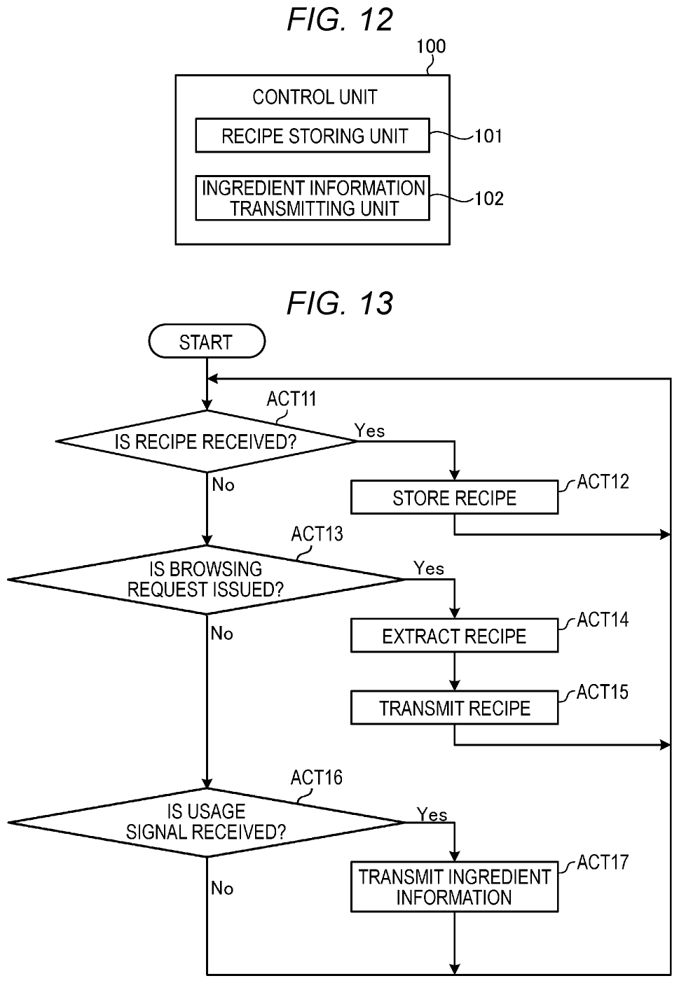

From here, a functional configuration of the recipe server 1 will be described. FIG. 12 is a functional block diagram illustrating the functional configuration of the recipe server 1. As illustrated in FIG. 12, the control unit 100 functions as a recipe storing unit 101 and an ingredient information transmitting unit 102 by following the control program stored in the ROM 12 and the control program portion 141 of the memory unit 14.

The recipe storing unit 101 stores recipes related to cooking of a dish disclosed by the restaurant T for each restaurant T and for each restaurant code received at the same time so that the recipe can be browsed from the user terminal 9 owned by the user P of the recipe. Specifically, the recipe storing unit 101 stores the recipe received from the restaurant terminal 2 for each restaurant code received at the same time and stores the recipe code that specifies the received recipe in the recipe code portion 1313 corresponding to the restaurant code portion 1311 in which the restaurant code of the recipe storage portion 131 is stored. The recipe storing unit 101 stores the received recipes in the corresponding recipe portion 1314 in the same manner. The recipe includes information that is unsuitable for the user P with a specific illness, and if the recipe is unsuitable for the user with a specific illness, the recipe storing unit 101 stores information indicating that fact in the remarks information portion 1315. The recipe storing unit 101 stores information on whether or not a recipe can be used for each type of allergy for a user with an allergic constitution in the remarks information portion 1315.

The user P operates the user terminal 9 to designate and browse the recipe stored in the recipe storage portion 131. If the user P uses the browsed recipe, the user operates the user terminal 9 to designate the recipe and performs a usage decision operation. If the recipe to be used is designated, the user terminal 9 transmits a usage signal indicating that usage of the recipe is decided and a user code to the recipe server 1.

The ingredient information transmitting unit 102 transmits the ingredient information related to the recipe for which the usage signal indicating that the usage thereof is decided is received from the user terminal 9 to the management server 7. Specifically, if the ingredient information transmitting unit 102 receives the usage signal from the user terminal 9, the ingredient information transmitting unit 102 transmits the ingredient information included in the recipe to the management server 7 together with the user code and the restaurant code.

From here, the control of the recipe server 1 will be described. FIG. 13 is a flowchart illustrating a flow of a control process of the recipe server 1. As illustrated in FIG. 13, the control unit 100 of the recipe server 1 determines whether the recipe and the restaurant code are received from the restaurant terminal 2 (ACT 11). If it is determined that the recipe and the restaurant code are received from the restaurant terminal 2 (Yes in ACT 11), the recipe storing unit 101 stores the recipe in the recipe storage portion 131 in correlation with the restaurant code (ACT 12). Then, the control unit 100 returns to ACT 11.

If it is determined that the recipe and the restaurant code are not received (No in ACT 11), the control unit 100 determines whether a recipe browsing request is issued from the user terminal 9 (ACT 13). If it is determined that the recipe browsing request is issued from the user terminal 9 (Yes in ACT 13), the control unit 100 extracts the recipe stored in the recipe portion 1314 (ACT 14). The control unit 100 basically extracts all the recipes stored in the recipe portion 1314, but for example, if a browsing request is issued with information on a specific illness, disease, allergy, and the like from the user terminal 9, the control unit 100 does not extract the recipe unsuitable for the illness or the like based on the information stored in the remarks information portion 1315. Then, the control unit 100 (browsing step) transmits the extracted recipe to the user terminal 9 so that the extracted recipe can be browsed (ACT 15). Then, the control unit 100 returns to ACT 11.

If transmitting the recipe to the user terminal 9, the control unit 100 (browsing step) transmits the recipe such that the recipe that the user used many times in the past is displayed at a higher level so as to be easily seen. Which recipe the user uses and how many times can be determined by obtaining a history of past electronic receipt information of the user stored in the electronic receipt information portion 5423 described later.

If it is determined that the recipe browsing request is not issued from the user terminal 9 (No in ACT 13), the control unit 100 determines whether or not a usage signal indicating that a specific recipe is to be used is received from the user terminal 9 (ACT 16). If it is determined that the usage signal is received (Yes in ACT 16), the ingredient information transmitting unit 102 transmits ingredient information related to the recipe for which the usage signal indicating that the recipe is to be used is received from the user terminal 9 to the management server 7 at the same time together with the user code received from the user terminal 9 and the restaurant code of the restaurant T that provided the recipe (ACT 17). Then, the control unit 100 returns to ACT 11.

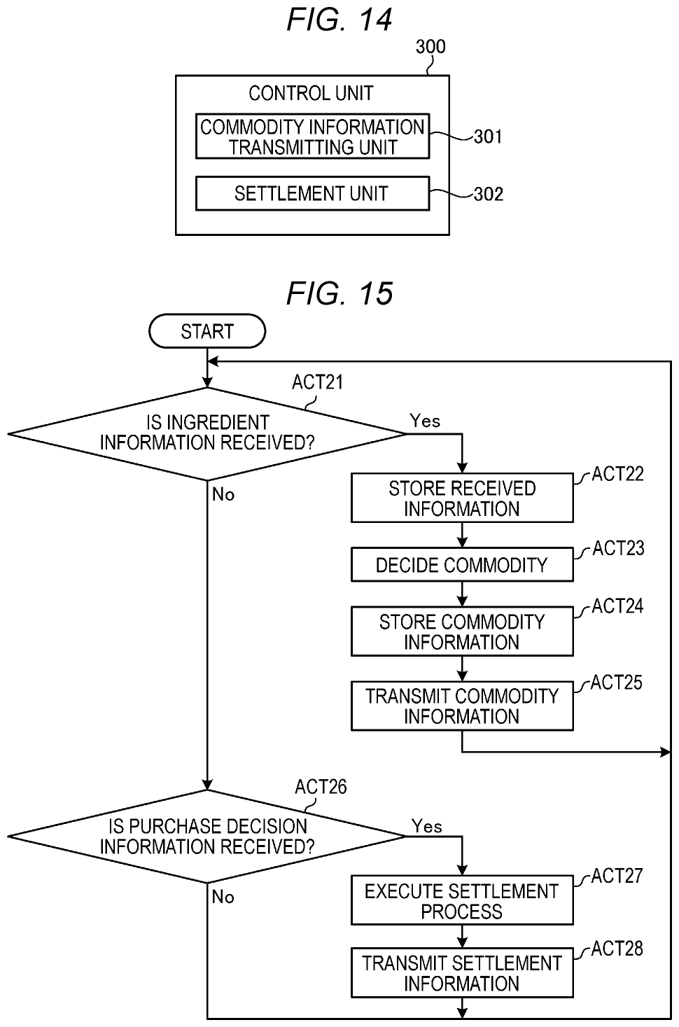

A functional configuration of the net supermarket server 3 will be described. FIG. 14 is a functional block diagram illustrating the functional configuration of the net supermarket server 3. As illustrated in FIG. 14, the control unit 300 functions as a commodity information transmitting unit 301 and a settlement unit 302 by following the control program stored in the ROM 32 and the control program portion 341 of the memory unit 34.

The commodity information transmitting unit 301 transmits the commodity information of the commodity corresponding to the ingredient extracted based on the received ingredient information to the management server 7. Specifically, if the commodity information transmitting unit 301 receives the ingredient information, the user code, the restaurant code transmitted by the recipe server 1 from the management server 7, the commodity information transmitting unit 301 decides the commodity corresponding to the ingredient based on the received ingredient information, and transmits the commodity information of the commodity and the user code to the management server 7.

The settlement unit 302 performs a settlement process related to the commodity based on the commodity information of the commodity corresponding to the ingredient of the dish included in the recipe that the user P decided to use among the recipes browsed on the recipe server 1. Specifically, if the settlement unit 302 receives a purchase signal indicating that the commodity displayed on the user terminal 9 is to be purchased based on the commodity information transmitted by the commodity information transmitting unit 301 to the management server 7 from the management server 7, the settlement unit 302 executes the settlement process based on the commodity information.

The control of the net supermarket server 3 will now be described. FIG. 15 is a flowchart illustrating a flow of a control process of the net supermarket server 3. As illustrated in FIG. 15, the control unit 300 of the net supermarket server 3 determines whether the ingredient information, the user code, and the restaurant code transmitted by the recipe server 1 in the process of ACT 17 are received from the management server 7 (ACT 21). If it is determined that the ingredient information, the user code, and the restaurant code are received (Yes in ACT 21), the control unit 300 stores the restaurant code in the restaurant code portion 3311 (ACT 22). The control unit 300 stores the user code in the user code portion 3312 correlated with the restaurant code portion 3311 that stores the restaurant code (ACT 22). The control unit 300 stores the received ingredient information in the ingredient portion 3313 (ACT 22).

Next, the control unit 300 determines a commodity corresponding to the ingredient based on the ingredient information stored in the ingredient portion 3313 (ACT 23). Next, the control unit 300 stores the commodity information of the determined commodity in the purchase commodity portion 332 together with the user code and the restaurant code (ACT 24). Next, the commodity information transmitting unit 301 transmits the commodity information stored in the purchase commodity portion 332 and the user code to the management server (ACT 25). Then, the control unit 300 returns to ACT 21.

If it is determined that the ingredient information, the user code, and the restaurant code are not received (No in ACT 21), the control unit 300 determines whether or not purchase decision information of the commodity for the commodity information transmitted in the process of ACT 25 is received from the management server 7 (ACT 26). If it is determined that the purchase decision information of the commodity is received (Yes in ACT 26), the settlement unit 302 (settlement step) executes the settlement process related to the commodity based on the commodity information stored in the purchase commodity portion 332 (ACT 27). Then, the control unit 300 transmits the purchase information of the commodity subjected to the settlement process to the management server 7 together with the restaurant code and the user code (ACT 28). Then, the control unit 300 returns to ACT 21. If it is determined that the purchase decision information of the commodity is not received (No in ACT 26), the control unit 300 returns to ACT 21.

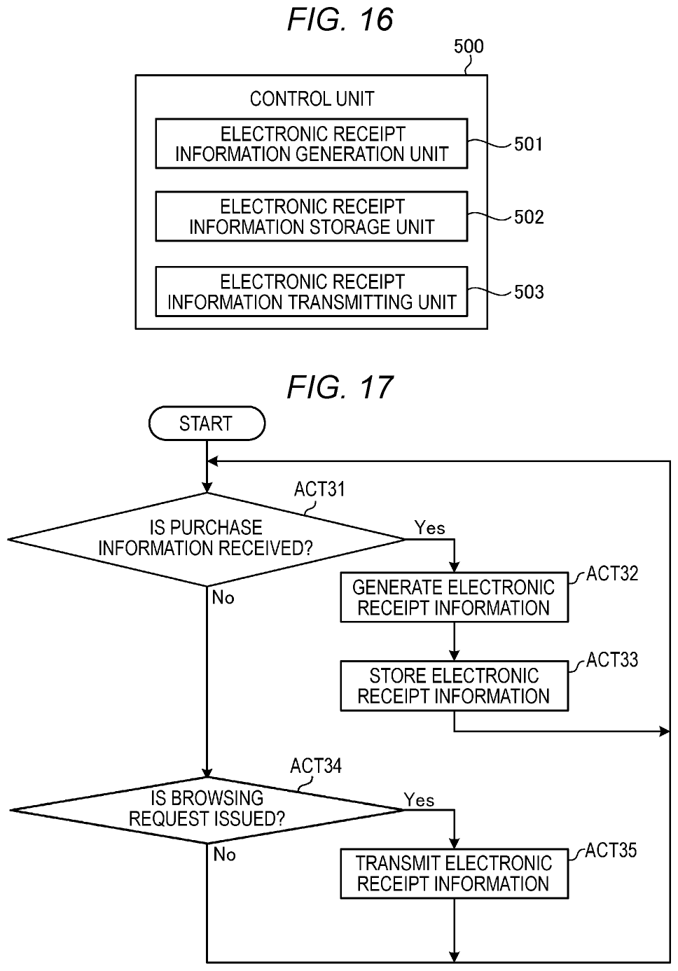

From here, a functional configuration of the electronic receipt server 5 will be described. FIG. 16 is a functional block diagram illustrating the functional configuration of the electronic receipt server 5. As illustrated in FIG. 16, the control unit 500 functions as an electronic receipt information generation unit 501, an electronic receipt information storage unit 502, and an electronic receipt information transmitting unit 503 by following the control program stored in the ROM 52 or in the control program portion 541 of the memory unit 54.

The electronic receipt information generation unit 501 generates electronic receipt information based on the purchase information of the commodity subjected to the settlement process received from the management server 7.

The electronic receipt information storage unit 502 stores the electronic receipt information related to the commodity subjected to the settlement process. Specifically, the electronic receipt information storage unit 502 cumulatively stores the electronic receipt information generated by the electronic receipt information generation unit 501 in the electronic receipt information portion 5423 correlated with the user code portion 5421 that stores the user code received at the same time.

The electronic receipt information transmitting unit 503 transmits the stored electronic receipt information to the user terminal 9. Specifically, if an electronic receipt information browsing request is issued from the user terminal 9 together with the user code, the electronic receipt information transmitting unit 503 transmits designated electronic receipt information to the user terminal 9 from which the electronic receipt information browsing request is issued.

The control of the electronic receipt server 5 will now be described. FIG. 17 is a flowchart illustrating a flow of a control process of the electronic receipt server 5. As illustrated in FIG. 17, the control unit 500 of the electronic receipt server 5 determines whether or not the purchase information of the commodity is received from the management server 7 or the restaurant terminal 2 (ACT 31). If it is determined that the purchase information of the commodity is received (Yes in ACT 31), the electronic receipt information generation unit 501 generates electronic receipt information based on the received purchase information (ACT 32). Then, the electronic receipt information storage unit 502 stores the electronic receipt information related to the commodity subjected to the settlement process (ACT 33). Then, the control unit 500 returns to ACT 31.

If it is determined that the purchase information of the commodity is not received (No in ACT 31), the control unit 500 determines whether or not the electronic receipt information browsing request is issued from the user terminal 9 (ACT 34). If it is determined that the electronic receipt information browsing request is issued (Yes in ACT 34), the electronic receipt information transmitting unit 503 transmits designated electronic receipt information stored in the electronic receipt information portion 5423 to the user terminal 9 (ACT 35). Then, the control unit 500 returns to ACT 31. If it is determined that the electronic receipt information browsing request is not issued (No in ACT 34), the control unit 500 returns to ACT 31.

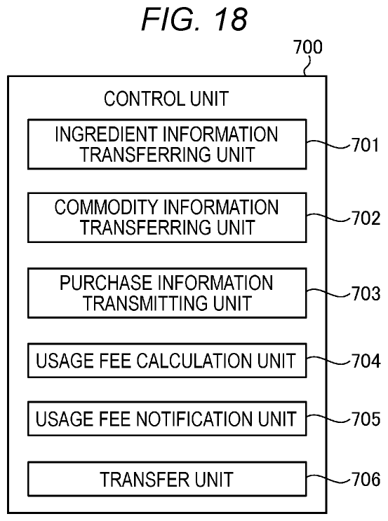

From here, a functional configuration of the management server 7 will be described. FIG. 18 is a functional block diagram illustrating the functional configuration of the management server 7. As illustrated in FIG. 18, the control unit 700 functions as an ingredient information transferring unit 701, a commodity information transferring unit 702, a purchase information transmitting unit 703, a usage fee calculation unit 704, a usage fee notification unit 705, and a transfer unit 706 by following the control program stored in the ROM 72 and the control program portion 741 of the memory unit 74.

The ingredient information transferring unit 701 (ingredient information transferring step) transmits the ingredient information received from the recipe server 1 to the net supermarket server 3. Specifically, the ingredient information transferring unit 701 transfers the ingredient information, the user code, and the restaurant code received from the recipe server 1 to the net supermarket server 3.

The commodity information transferring unit 702 (commodity information transferring step) transmits the commodity information received from the net supermarket server 3 to the user terminal 9. Specifically, the commodity information transferring unit 702 searches the user address portion 7422 based on the user code received from the net supermarket server 3 with the commodity information received from the net supermarket server 3, acquires the address of the user terminal 9, and transmits the commodity information to the address in a displayable manner.

The purchase information transmitting unit 703 transmits the purchase information of the commodity subjected to the settlement process by the net supermarket server 3 to the electronic receipt server 5. Specifically, the purchase information transmitting unit 703 transmits the purchase information of the commodity subjected to the settlement process by the net supermarket server 3 to the electronic receipt server 5 together with the user code.

The usage fee calculation unit 704 calculates a usage fee to be paid to the restaurant T as compensation for using the recipe, based on the purchase information of the commodity subjected to the settlement process by the net supermarket server 3. Specifically, the usage fee calculation unit 704 calculates the usage fee by multiplying a settlement amount included in the purchase information of the commodity subjected to the settlement process by the net supermarket server 3 by a predetermined rate (for example, 5% of the settlement amount). If this usage fee is included in the settlement price, the usage fee will be borne by an actual user. This usage fee may be borne by the store that operates the net supermarket server 3.

The usage fee notification unit 705 (usage fee notification step) notifies the restaurant T of the recipe usage fee calculated based on the settlement amount obtained by being subjected to the settlement process. Specifically, the usage fee notification unit 705 notifies the restaurant terminal 2 of the restaurant T, whose recipe is used, of the usage fee information calculated by the usage fee calculation unit 704.

The transfer unit 706 transfers the usage fee calculated by the usage fee calculation unit 704 to a designated account of the financial institution with which the restaurant T has a contract. Alternatively, the transfer unit 706 remits the usage fee calculated by the usage fee calculation unit 704 to the restaurant terminal 2 or the designated terminal in the form of electronic money. The transfer unit 706 may be any unit for paying the usage fee to the restaurant T, and is not limited to the account transferor the remittance of electronic money.

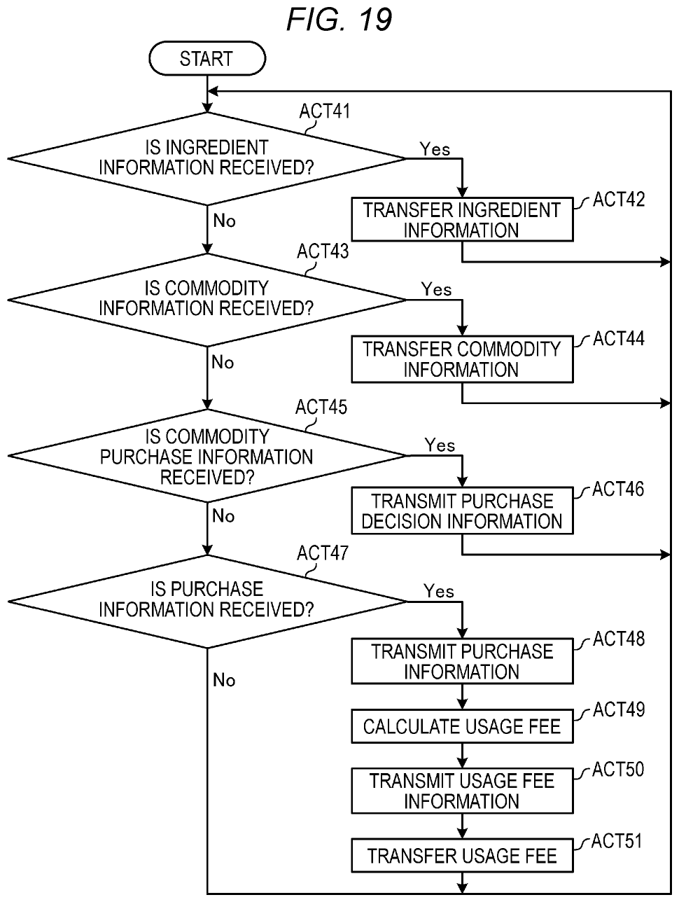

From here, the control of the management server 7 will be described. FIG. 19 is a flowchart illustrating a flow of a control process of the management server 7. As illustrated in FIG. 19, the control unit 700 of the management server 7 determines whether or not ingredient information is received from the recipe server 1 (ACT 41). If it is determined that the ingredient information is received from the recipe server 1 (Yes in ACT 41), the ingredient information transferring unit 701 (ingredient information transferring step) transfers the ingredient information received from the recipe server 1 to the net supermarket server 3 together with the user code and the restaurant code (ACT 42). Then, the control unit 700 returns to ACT 41.

If it is determined that the ingredient information is not received from the recipe server 1 (No in ACT 41), the control unit 700 determines whether the commodity information and the user code are received from the net supermarket server 3. If it is determined that the commodity information and the user code are received from the net supermarket server 3 (Yes in ACT 43), the commodity information transferring unit 702 (commodity information transferring step) transmits the received commodity information to the user terminal 9 specified by the user code (ACT 44). Then, the control unit 700 returns to ACT 41.

If it is determined that the commodity information and the user code are not received from the net supermarket server 3 (No in ACT 43), the control unit 700 determines whether the commodity purchase information that decided the purchase of the commodity is received from the user terminal 9 (ACT 45). If it is determined that the commodity purchase information is received (Yes in ACT 45), the control unit 700 transmits the purchase decision information that decided to purchase the commodity for the recipe decided to be used to the net supermarket server 3 (ACT 46). Then, the control unit 700 returns to ACT 41.

If it is determined that the commodity purchase information is not received from the user terminal 9 (No in ACT 45), the control unit 700 determines whether the purchase information and the user code are received from the net supermarket server 3 (ACT 47). If it is determined that the purchase information and the user code are received from the net supermarket server 3 (Yes in ACT 47), the purchase information transmitting unit 703 transmits the received purchase information together with the user code to the electronic receipt server 5 (ACT 48). Then, the usage fee calculation unit 704 calculates the usage fee to be paid to the restaurant T as compensation for using the recipe based on the settlement information included in the received purchase information (ACT 49). Then, the usage fee notification unit 705 (usage fee notification step) notifies the restaurant terminal 2 of the restaurant T, whose recipe is used, of the usage fee information calculated by the usage fee calculation unit 704 (ACT 50). For example, the restaurant may receive a message as a notification indicating the usage fee information.

Next, the transfer unit 706 transfers the usage fee of the recipe calculated by the usage fee calculation unit 704 to a designated account of a financial institution registered in advance. Alternatively, the transfer unit 706 remits the electronic money equivalent to the recipe usage fee to a designated terminal such as the restaurant terminal 2.

According to such an embodiment, since the user P can use the recipe disclosed by the restaurant T, the taste of the dish at the restaurant can be reproduced. The restaurant T can obtain a usage fee as compensation for disclosing the recipe. In the store operating the net supermarket server 3, usage of recipes can lead to sale of commodities related to ingredients thereof.

As described above, the recipe providing system S of the embodiment includes the recipe server 1, the net supermarket server 3 that sells the commodity using a network, and the management server 7. The recipe server 1 includes the recipe storing unit 101 for storing recipes related to preparing (e.g., cooking) of a meal item (a dish) provided by the restaurant T for each restaurant T so that the recipes can be browsed from the user terminal 9 owned or otherwise accessible by the user P of the recipe, the net supermarket server 3 includes the settlement unit (processor) 302 for performing the settlement process related to a commodity based on commodity information of the commodity corresponding to ingredients of the dish included in the recipe to be used among the recipes browsed by the user P on the recipe server 1, and the management server 7 includes the usage fee notification unit 705 for notifying the restaurant T of the recipe usage fee calculated based on the settlement amount obtained by being subjected to settlement process.

In the recipe providing system S having such a configuration, by disclosing the recipe of the restaurant T by the recipe server 1, the user P can reproduce the taste of the dish at the restaurant T and the management server 7 can notify the usage fee for disclosing the recipe.

The foregoing embodiments are presented by way of example only and are not limiting. Other embodiments may include various modifications, as explained below.

For example, in the embodiment, the recipe server 1 stores the recipe of the restaurant T, which is a member that uses the electronic receipt mechanism. However, the recipe server 1 is not limited to this, and may store the recipe of the desired restaurant T regardless of whether the electronic receipt mechanism is used or not.

In at least one embodiment, the description is made in which the recipe server 1, the net supermarket server 3, the electronic receipt server 5, and the management server 7 configure the recipe providing system S. However, at least one embodiment is not limited to this, and the recipe providing system S may be configured with at least the recipe server 1, the net supermarket server 3, and the management server 7 with the electronic receipt server 5 not included in the recipe providing system S.

In at least one embodiment, the description is made in which the electronic receipt server 5 generates electronic receipt information. However, the embodiments are not limited to this, and for example, the net supermarket server 3 or the management server 7 may generate the electronic receipt information.

The net supermarket server 3 described as one component of the recipe providing system S in at least one embodiment may be a server for purchasing commodities displayed in a physical store in online, but may also be a server for purchasing commodities in online shopping in a virtual store that does not have the physical store.

The program executed by the management server 7 of the embodiment is provided by being recorded on a computer-readable recording medium (e.g., a non-transitory medium) such as a CD-ROM, flexible disc (FD), CD-R, or digital versatile disk (DVD) or other memory in a file of an installable or executable format.

A configuration in which the program executed by the management server 7 of at least one embodiment is provided by being stored on a computer connected to a network such as the Internet and downloaded via the network may be adopted. A configuration in which the program executed by the management server 7 of at least one embodiment is provided or distributed via a network such as the Internet may be adopted.

A configuration in which the programs executed by the management server 7 of at least one embodiment are provided by being respectively incorporated into ROM or the like may be adopted.

While certain embodiments have been described, these embodiments have been presented by way of example only, and are not intended to limit the scope of the inventions. Indeed, the novel embodiments described herein may be embodied in a variety of other forms. Furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A recipe providing system comprising:
a recipe server;
a net supermarket server configured to offer a commodity via a network; and
a management server,
the recipe server including:
a recipe storage configured to store at least one recipe related to preparation of a meal item, the meal item provided by a restaurant for each restaurant such that the at least one recipe is browsable from a user terminal accessible by a user,
the net supermarket server including:
a processor configured to perform a settlement process related to a commodity based on commodity information of the commodity, the commodity information corresponding to one or more ingredients of the dish included in a recipe to be used among the at least one recipe browsed by the user on the recipe server, and
the management server being configured to provide a usage fee notification to notify the restaurant of a recipe usage fee calculated based on a settlement amount obtained via the settlement process.

2. The system according to claim 1, wherein
the recipe server includes an ingredient information transmitter configured to transmit ingredient information related to the at least one recipe for which a signal indicating that the at least one recipe is to be used is received from the user terminal to the management server,
the management server is configured to transmit the ingredient information received from the recipe server to the net supermarket server,
the net supermarket server is configured to transmit commodity information of a commodity corresponding to the ingredient extracted based on the received ingredient information to the management server, and
the management server is configured to transmit the received commodity information to the user terminal.

3. The system according to claim 1, further comprising:
an electronic receipt server including:
an electronic receipt information storage configured to store electronic receipt information related to the commodity subjected to the settlement process, and
an electronic receipt information transmitter configured to transmit the stored electronic receipt information to the user terminal, wherein
the management server is configured to transmit purchase information of the commodity subjected to the settlement process by the net supermarket server to the electronic receipt server.

4. A recipe providing method in a recipe providing system including a recipe server, a net supermarket server that sells a commodity using a network, and a management server, the method comprising:
allowing a recipe for preparation of a meal item provided by a restaurant to be browsed from a user terminal accessible by a user of the recipe;
transmitting ingredient information related to the recipe stored in the recipe server to the net supermarket server;
transmitting commodity information of a commodity corresponding to the ingredient information extracted by the net supermarket server based on the ingredient information transmitted to the user terminal in a displayable manner;
performing a settlement process related to the commodity in response to a purchase signal from the user terminal; and
notifying the restaurant of a recipe usage fee calculated based on a settlement amount obtained by being subjected to the settlement process.

5. A management server connected to a recipe server, a net supermarket server, and an electronic receipt server, the management server comprising:
an ingredient information transmitting means for transmitting ingredient information related to a recipe stored in the recipe server and received from the recipe server to the net supermarket server;
a settlement information transmitter for transmitting settlement information obtained by being subjected to a settlement process by the net supermarket server to the electronic receipt server; and
a communication interface configured to notify a restaurant of a recipe usage fee calculated based on a settlement amount obtained via the settlement process.

6. A management method in a management server connected to a recipe server, a net supermarket server, and an electronic receipt server, the management method comprising:
transmitting ingredient information related to a recipe stored in the recipe server and received from the recipe server to the net supermarket server;
transmitting settlement information obtained by being subjected to a settlement process by the net supermarket server to the electronic receipt server; and
notifying a restaurant of a recipe usage fee calculated based on a settlement amount obtained by being subjected to the settlement process.

7. The system according to claim 1, wherein each recipe includes information relating to a timing and an order of ingredients.

8. The system according to claim 1, further including a restaurant terminal, associated with a restaurant, configured to transmit recipes to the recipe server.

9. The system according to claim 8, wherein the restaurant terminal includes at least one of a personal computer, a smartphone, or a tablet.

10. The system according to claim 1, wherein the user terminal includes at least one of a personal computer, a smartphone, or a tablet.

11. The system according to claim 1, where the recipe storage is configured to store information regarding allergies, illness, or disease associated with one or more ingredients of a recipe.

12. The system according to claim 1, where the recipe server causes recipes browsed to be listed in a priority order.

13. The system according to claim 12, where the priority order is based on an amount of usage of the recipes by the user.

14. The method according to claim 4, wherein each recipe includes information relating to a timing and an order of ingredients.

15. The method according to claim 4, further comprising transmitting, by a restaurant terminal associated with a restaurant, recipes to the recipe server.

16. The method according to claim 14, wherein the restaurant terminal includes at least one of a personal computer, a smartphone, or a tablet.

17. The method according to claim 4, wherein the user terminal includes at least one of a personal computer, a smartphone, or a tablet.

18. The method according to claim 4, further comprising causing a memory to store information regarding allergies, illness, or disease associated with one or more ingredients of a recipe.

19. The method to claim 4, further comprising causing, by the recipe server, the recipes that are browsed to be listed in a priority order.

20. The method according to claim 19, where the priority order is based on an amount of usage of the recipes by the user.
